(19) United States
(12) Patent Application Publication
(10) Pub. No.: US 2001/0030272 A1
(43) Pub. Date: Oct. 18, 2001

(54) Holder for printed material

(76) Inventor: Akram W. Moore, Vadito, NM (US)

Correspondence Address: ROBERT W. BECKER & ASSOCIATES, Suite B, 11896 N. Highway 14, Ti eras, NM, 87059, US

(21) Appl. No.: 09/732,997

(22) Filed: Dec. 7, 2000

Related U.S. Application Data
(60) Provisional application No. 60/169,523, filed on Dec. 7, 1999.
(60) Provisional application No. 60/202,314, filed on May 5, 2000.

(51) Int. Cl. F16M 11/00; A45D 19/04; A47J 47/16

(52) U.S. Cl. 248/441.1; 248/174

(57) ABSTRACT

A holder, for written or printed material, especially for use with a computer monitor, is provided. The holder has a panel that is intended to be placed under a computer monitor. A support member for printed material is connected to the panel and extends at an angle therefrom. A raised lip can be interposed between the panel and the support member, with the lip extending perpendicular to the panel, and the support member extending at an acute angle from the lip.

### RELATED APPLICATIONS

The present non-provisional application is based upon U.S. Provisional Application No. 60/169,523, filed on Dec. 7, 1999, and No. 60/202,314 filed on May 5, 2000; these provisional applications are incorporated herein by this reference thereto.

### BACKGROUND OF THE INVENTION

The present invention relates to a holder for written or printed material, and is intended in particular for use with a computer monitor.

Computer work stations typically provide no convenient place to put the material that is being worked on. If a large enough work station is provided, the printed or written material that is being worked on can be placed next to the computer. However, this requires the user to continuously have to look to the side, in other words away from the keyboard and the computer monitor. In other cases, the work material even has to be placed on the user's lap or in some other inconvenient location.

It is therefore an object of the present invention to provide a convenient and ergonomic holder for written or printed material.

### BRIEF DESCRIPTION OF THE DRAWINGS

This object, and other objects and advantageous of the present invention, will appear more clearly from the following specification in conjunction with the accompanying schematic drawings, in which:

FIG. 1 shows one exemplary embodiment of an inventive holder for printed material;

FIG. 2 shows a further exemplary embodiment of an inventive holder for printed material; and

FIG. 3 shows yet another exemplary embodiment of an inventive holder for printed material.

### SUMMARY OF THE INVENTION

The holder of the present invention, which is intended in particular for use with a computer monitor, comprises a panel that is intended for placement under a computer monitor, and a support member, for printed material, which is connected to the panel and extends downwardly at an angle therefrom. A raised lip can be interposed between the panel and the support member. The lip extends perpendicular to the panel, and the support member extends at an acute angle from the lip.

The unique advantage provided by the holder of the present invention is that now papers or other material being worked on will be placed right in front of the user. In particular, since the panel of the inventive holder is placed under the monitor, and the support member that holds the printed material extends at an angle downwardly away from the monitor, the printed material will be disposed right in front of the user's eyes, namely between the keyboard and the computer monitor.

Further specific features of the present invention will be described in detail subsequently.

### DESCRIPTION OF PREFERRED EMBODIMENTS

While the various features of this invention are hereinafter illustrated and described as providing a written material holder for use with a computer, it is to be understood that the various features can be utilized singly or in various combinations thereof to provide a written or printed material holder for other applications where it is necessary to save space and/or provide a convenient holder for written or printed material in front of a work area.

Therefore, this invention is not to be limited to only the embodiments illustrated in the drawings, because the drawings are merely utilized to illustrate one of the wide variety of uses of this invention.

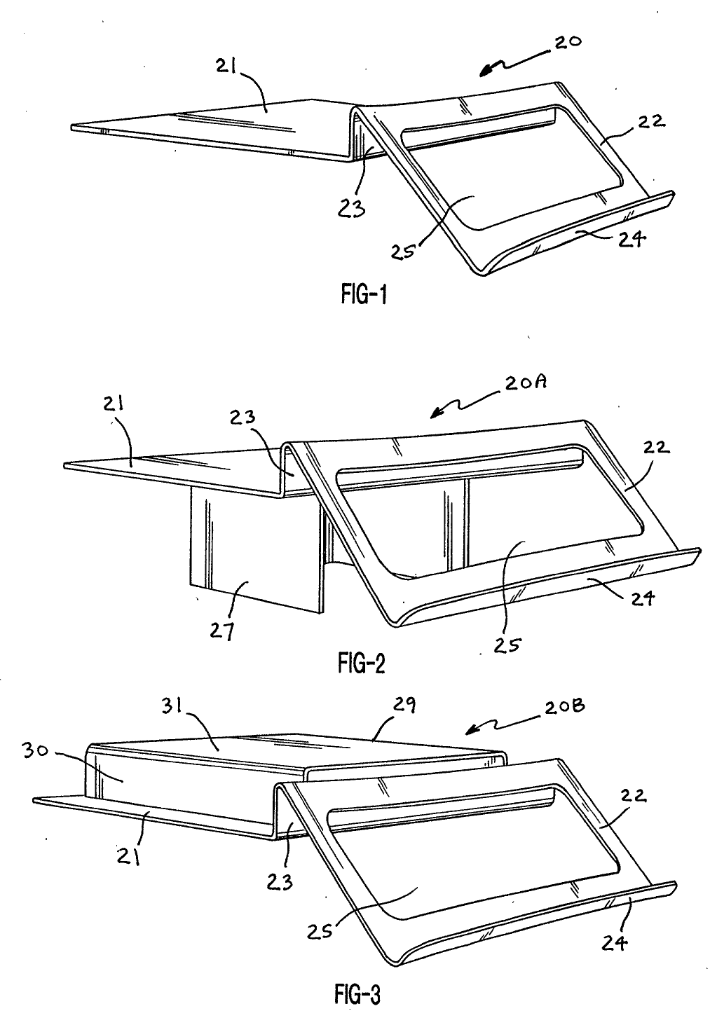

Referring now to the drawings in detail, FIG. 1 illustrates a first exemplary embodiment of an inventive holder for written material, which is indicated generally by the reference numeral 20. The written material holder 20 comprises a panel 21 that is intended for placement under a computer monitor, and in particular a computer monitor that is seated on a CPU or is otherwise raised above the level of, for example, a keyboard.

A support member 22 for written material is connected to the panel 21. So that written material, such as books, papers, drawings, etc., (subsequently referred to generally as written or printed material) can be conveniently supported for ease of viewing by a user, the support panel 22 extends downwardly and away from the panel 21 at an angle, for example an angle of 30° to 60° and in one preferred embodiment of the present invention at an angle of 45° relative to the panel 21. In order to provide sufficient height to the support member 22 to allow such support member to extend down far enough to accommodate written material, the support member 22 is connected to the panel 21 by a raised member or lip 23. In the illustrated embodiment, the lip 23 extends upwardly perpendicular to the panel 21, with the support member 22 then extending at an angle downwardly from the upper end of the lip 23. The lip 23 is of such a height that while it raises the level of the support member 22, it does not block the computer monitor.

Pursuant to one preferred specific embodiment of the present invention, a further lip 24 is provided at the lower end of the support member 22 for holding written material on the support member. This lip 24 extends upwardly from the support member 22, and in one preferred embodiment extends perpendicular to the support member 22.

In the embodiment of the written material holder 20 illustrated in FIG. 1, the support member 22 is illustrated as being provided with a cutout or hole 25, for example to allow access to a CPU, especially in order to be able to insert a disk therein. It is to be understood, of course, that the support member 22 could also be a solid panel. Conversely, whereas in the illustrated embodiment the panel 21 is illustrated as being solid, it could also be provided with a cutout, for example in order to save material.

Although the embodiment illustrated in FIG. 1 provides merely for a simple panel 21, it has been found according to the teachings of this invention that other configurations are also possible. For example, reference is now made to FIGS. 2 and 3, which illustrate other written material holders of the present invention and are generally indicated by the reference numerals 20A and 20B, wherein parts thereof similar to the written material holder 20 of FIG. 1 are indicated by like reference numerals that where appropriate are followed by the reference letter A or B.

The embodiment of an inventive written material holder illustrated in FIG. 2 differs from the embodiment of FIG. 1 primarily in that a riser 27 is provided beneath the panel 21. This riser 27 serves to raise the height of the holder, and hence of the monitor placed upon the panel 21, so that there will be sufficient height for the support member 22. The use of a riser 27 is contemplated especially for the situation where the monitor does not rest upon a CPU. Again, the support member 22 can be provided with a cutout 25, if desired, to provide access to the space below the panel 21. In the illustrated embodiment, the riser 27 comprises two legs, which can either be separate legs or the riser can have a U-shaped configuration, which adds to the stability of the unit.

The inventive written material holder 20B illustrated in FIG. 3 is also provided with a riser 29. In this embodiment, rather than being disposed below the panel 21 as is the case with the embodiment of FIG. 2, here the riser 29 is disposed on the upper side of the panel 21. This embodiment is particularly useful for lower-style monitors, and raises the monitor sufficiently so that the support member 22 and/or the written material disposed thereon will not block any of the monitor screen. As with the embodiment of FIG. 1, the holder illustrated in FIG. 3 can be placed upon a CPU or some other object. The riser 29 has a U-shaped cross-sectional configuration, with legs 30 that are attached to or rest upon the panel 21. The legs 30 are interconnected by a top panel 31, upon which a computer monitor can be placed. In this embodiment, again the panel 21 can be a solid sheet, or could end on each side adjacent to the legs 30 of the riser 29.

Although it is presently preferred that in particular the embodiment of FIG. 1 be a single, i.e. monolithic, member, it is also possible for at least some of the components to be separate pieces that are then interconnected. This is particularly true of the embodiments of FIGS. 2 and 3, where the risers can be separate components. In particular, in the embodiment of FIG. 2, the basic unit, and in particular the panel 21 thereof, could be placed upon a separate riser 27, which need not necessarily be attached to the panel 21. Again, the entire unit could be a monolithic unit, especially if the holder is made of polymeric material. Similarly, with the embodiment of FIG. 3 the riser 29 could be a separate component which could merely rest upon the panel 21 or could be attached thereto. Again, the entire unit could be a monolithic unit.

The risers 27 and 29 can, of course, be of varying heights to fit particular applications. In addition, the risers could be stackable upon one another to reach the desired height. In addition, rather than having the configuration illustrated, either of the risers 27, 29 could have any other desired shape, and could even have a rotatable top plate, which is particularly suitable for the embodiment of FIG. 3 to allow rotation of a monitor placed thereupon.

As indicated above, the inventive written material holder can be made of a suitable polymeric material, such as ABS, polyethylene, acrylic, or the like. In addition, the unit could also be made of metal or even wood.

As previously discussed, although the inventive written material holders are preferably monolithic components, the various components of the holders could also be separate parts. For example, at least some of the components could be hinged to one another to allow at least partial folding of the holder. In addition, the risers could be constructed so as to be adjustable in height. For example, the legs could slide relative to one another and be secured in position by appropriate bolts or the like. Similarly, the support member could be adjustable in length to accommodate the amount of space that is available. In addition, it would be possible to hinge the support member 22 either directly to the panel 21 or to the lip 23 for the purpose of being able to adjust the angle of the support member 22 relative to the panel 21. Reinforcing ribs could also be provided for the inventive holders, especially where the support member 22 adjoins the lip 23.

Accessories could also be provided for the inventive written material holders. For example, pen and pencil holders, disk containers, or the like could be provided and could be adapted to be hooked or otherwise secured to the support member 22. Clips or the like to hold written material on the support member could also be provided.

The thickness of the various components can vary depending upon the material and the strength desired. Finally, the inventive written material holders can be made of any desired color.

The present invention is, of course, in no way restricted to the specific disclosure of the specification and drawings, but also encompasses any modifications within the scope of the appended claims.

### What I claim is:

1. A holder, for printed material, for use with a computer monitor, comprising:
a panel for placement under a computer monitor, and;
a support member for printed material, wherein said support member is connected to said panel and extends at an angle therefrom.

2. A holder according to claim 1, wherein a raised lip is interposed between said panel and said support member, wherein said raised lip extends perpendicular to said panel and wherein said support member extends at an acute angle from said raised lip.

3. A holder according to claim 2, wherein said support member is provided with a further lip, remote from where said support member adjoins said raised lip, for holding printed material on said support member.

4. A holder according to claim 3, wherein said further lip extends perpendicular to a plane of said support member.

5. A holder according to according to claim 1, wherein said support member is connected directly to said panel.

6. A holder according to claim 5, wherein said support member is provided with a further lip, remote from where said support member adjoins said panel, for holding printed material on said support member.

7. A holder according to claim 6, wherein said further lip extends perpendicular to a plane of said support member.

8. A holder according to claim 1, wherein said support member extends at an angle of 30-60° from said panel.

9. A holder according to claim 8, wherein said angle is approximately 45°.

10. A holder according to claim 2, which includes a riser, wherein said panel is disposed on said riser.

11. A holder according to claim 10, wherein said riser is U-shaped.

12. A holder according to claim 2, which includes a riser that is disposed on said panel for placement under a computer monitor.

13. A holder according to claim 12, wherein said riser is U-shaped, including two legs disposed on said panel and a panel that interconnects said legs for placement under a computer monitor.

14. A holder according to claim 2, wherein said holder is a monolithic unit.

15. A holder according to claim 2, wherein at least some of the components thereof are hingedly connected to one another.

16. A holder according to claim 2, wherein at least some of the components thereof are moveable relative to one another.

17. A holder according to claim 2, wherein said panel is a solid sheet of material.

18. A holder according to claim 2, wherein said support member is provided with a cutout.

19. A holder according to claim 2, wherein components thereof are made of polymeric material, metal or wood.
